(19) United States
(12) Patent Application Publication
(10) Pub. No.: US 2018/0202361 A1
(43) Pub. Date: Jul. 19, 2018

(54) PRESSURE RESPONSIVE VALVE FOR A COOLING FLOW IN A GAS TURBINE

(71) Applicant: ROLLS-ROYCE plc, London (GB)

(72) Inventor: Keith C. SADLER, Bristol (GB)

(73) Assignee: ROLLS-ROYCE plc, London (GB)

(21) Appl. No.: 15/869,165

(22) Filed: Jan. 12, 2018

(30) Foreign Application Priority Data
Jan. 17, 2017 (GB) 1700763.4

(51) Int. Cl. F02C 7/18; F02C 9/18; F02C 9/20; F01D 11/24; F16K 31/126

(52) U.S. Cl. CPC F02C 7/18; F02C 9/18; F02C 9/20; F05D 2270/42; F16K 31/126; F05D 2260/201; F01D 11/24

(57) ABSTRACT

There is disclosed a pressure responsive valve 352 for controlling a cooling flow through an orifice 320 in a gas turbine assembly 300. The valve 352 comprises an attachment point 360, a valve element 358, and a compressible valve body 354 defining a chamber 355 for sealing a volume of compressible gas. The valve body 354 is configured to act between the attachment point 360 and the valve element 358 so that in use expansion or contraction of the valve body 354 in response to external pressure causes the valve element 358 to move relative the orifice 320. A corresponding kit, method of installation and gas turbine assembly are disclosed.

### CROSS-REFERENCE TO RELATED APPLICATION

This application is based upon and claims the benefit of priority from British Patent Application No. 1700763.4 filed 17 Jan. 2017, the entire contents of which are incorporated herein.

### FIELD OF DISCLOSURE

The present disclosure relates to a pressure responsive valve (also referred to as a passively actuating valve) for controlling a cooling flow through an orifice in a gas turbine assembly.

### BACKGROUND

Gas turbine engines operate by continuously sequentially compressing, heating (by combustion) and expanding a core gas flow. The core gas flow is compressed to higher pressure and temperature in a compressor, further heated by combustion in a combustion chamber, and expanded through a turbine. The temperature of the core gas flow is typically so high upon entry to the turbine stage that components in this region require cooling.

It is known to provide such cooling by directing gas flow from other portions of the engine to components in the turbine stage, such as to the interior of a high pressure nozzle guide vane and a high pressure turbine blade. For example, such a cooling flow gas may be sourced from the high pressure compressor, bypassing the combustor. This flow may still be very high in temperature (for example, 800° C.), but may be referred to as a cooling flow as it has a cooling effect on the components in the turbine stage which are exposed to the higher temperature core gas flow from the combustor.

Pathways are defined in the gas turbine core (i.e. the part of the gas turbine within the casing enclosing the compressor, combustor and turbine) for the cooling flow, the flow rate of which is driven by pressure differentials between different portions of the pathway.

GB2015085 describes an air cooled gas turbine engine which includes a cooling flow valve for regulating cooling air flow to a turbine rotor in accordance with compressor discharge pressure and the operating temperature of the turbine component by means of a pressurizable diaphragm carrying a movable valve element with respect to a fixed valve seat. The means are in the form of another valve which is associated with the diaphragm to define a pressurizable internal cavity communicated with compressor discharge pressure by means of a control orifice to bias the diaphragm and valve element into a closed position when the compressor discharge pressure is at engine cruise condition and wherein as the temperature of operating turbine blades increase means are provided to sense such temperature increase and to bleed air from the pressurizable chamber thereby to cause the movable valve element to cycle with respect to the fixed valve seat so as to modulate coolant flow to the turbine in a manner to maintain optimized engine power output along with improved fuel consumption characteristics.

### BRIEF SUMMARY

The present disclosure provides a pressure responsive valve, kit of parts, gas turbine assembly and method of assembly according to the appended claims.

Disclosed herein is a pressure responsive valve (also referred to as a passively actuating valve) for controlling a cooling flow through an orifice in a gas turbine assembly, the valve comprising: an attachment point; a valve element; and a compressible valve body defining a chamber for sealing a volume of compressible gas; wherein the valve body is configured to act between the attachment point and the valve element so that in use expansion or contraction of the valve body in response to external pressure causes the valve element to move relative the orifice.

The expression “gas turbine assembly” is intended to mean an assembly of gas turbine components, for example a module or sub-assembly of a gas turbine. For example, the gas turbine assembly may comprise components which at least partly define a pathway for a cooling flow for a high pressure nozzle guide vane and/or high pressure turbine blade.

The compressible valve body may seal a volume of compressible gas in the chamber. The valve element may define a wall of the chamber. The valve element may be a flat plate. The valve element may be of any suitable shape. For example, the valve element may be circular, square or rectangular. The valve element may be planar (flat) or may be profiled. For example, the valve element may be conical or frustoconical.

The valve element may be configured so that part of the valve element can extend through the orifice in use.

The valve body may be in the form of a bellows. The valve body may of any suitable shape. For example, the valve body may be substantially cylindrical or cuboidal. The valve body may be mechanically biased to a baseline configuration (i.e. a baseline shape).

The attachment point may comprises a stud for a ball joint. Accordingly, the valve may be positioned by pivoting movement about the stud (i.e. about the ball joint) and subsequently fixed in place. The attachment point may comprise a shaft configured to be clamped in a co-operating mount.

A kit for controlling a cooling flow through an orifice in a gas turbine assembly may comprise: a pressure responsive valve as disclosed herein; a guide for mounting in fixed relationship with respect to the orifice; wherein the guide is configured to co-operate with the valve to guide movement of the valve element relative the orifice to meter the cooling flow.

For example, the guide may be for mounting on a first component of the gas turbine assembly in which the orifice is provided. The guide may be for mounting on a second component of the gas turbine assembly in fixed relationship with respect to a first component of the gas turbine assembly in which the orifice is provided.

The guide may have a stop configured to cooperate with the valve to limit movement of the valve element towards or away from the orifice. The stop may be configured to cooperate with the valve element to limit movement of the valve element towards or away from the orifice. The stop may be in the form of a shoulder. The stop may be configured to cooperate with the valve to limit movement of the valve element towards the orifice at a minimum flow position in which the valve element is spaced apart from a boundary of the orifice. The guide may define an opening for a by-pass flow between the valve element and the boundary of the orifice when the valve element is in the minimum flow position. In other words, the guide and valve element may be configured so that the valve element does not close the orifice when in the minimum flow position.

The guide may have a base for engaging a surface defining a boundary of the orifice, and the stop may be configured to cooperate with the valve to limit movement of the valve element towards the orifice at a minimum flow position in which the valve element is spaced apart from the respective boundary.

The guide may comprise a peripheral guide wall having an opening corresponding to the orifice. The peripheral guide wall may comprise two or more discrete guide wall elements spaced apart around the opening.

The attachment point of the valve may comprise a stud for a ball joint. The kit may further comprise a mount for attaching the attachment point to the gas turbine assembly. The mount comprising a socket (or recess) configured to cooperate with the stud for pivoting of the valve into an installation position. The mount may further comprise a clamp for clamping the valve in the installation position.

A gas turbine assembly may comprise: a fluid pathway for a cooling flow; a first component having an orifice for the cooling flow; a valve in accordance with the first aspect, wherein the valve is mounted in the assembly so that the valve element opposes the orifice and is moveable relative the orifice in response to pressure variations in the cooling flow.

The gas turbine assembly may comprise an annular combustor located around a principal axis of rotation. The pressure responsive valve may be located in radially inwards of the combustor. The combustor may include an annular combustion chamber and a radially inner combustor inner casing. The pressure responsive valve may be located radially inwards of the combustor inner casing. The orifice may be in a wall of the combustor inner casing. The combustor inner casing may be a combustor rear inner casing.

The gas turbine assembly may comprise a compressor and a turbine. The fluid pathway may extend between the compressor and the turbine. The pathway may be for a cooling flow for a high pressure nozzle guide vane or turbine blade.

There may be a plurality of pressure responsive valves. The plurality of pressure responsive valves may be located circumferentially around the principal axis. There may be between 8 and 16 valves distributed about the circumference of the first component, which may be the combustor inner casing. The plurality of pressure responsive valves may be independent from one another. The plurality of pressure responsive valves may be configured to have similar operating characteristics. For example, the pressure responsiveness of the pressure responsive valves may be the same.

The valve may be mounted to the first component having the orifice, or to a second component, which may oppose the first component. For example, the first component may be a combustion inner casing, and the valve may be mounted to a windage shield between the combustion inner casing and a shaft of the engine. The windage shield may be mounted to the combustion inner casing.

The gas turbine assembly may further comprising a guide mounted to or integrally formed with the first component. The guide may be configured to co-operate with the valve to guide movement of the valve element relative the orifice.

The guide may have a stop as described above with respect to the second aspect of the present disclosure. In particular, the guide may have a stop configured to cooperate with the valve to limit movement of the valve element towards or away from the orifice.

The guide may have a stop configured to cooperate with the valve to limit movement of the valve element towards the orifice at a minimum flow position in which the valve element is spaced apart from the boundary of the opening.

There may be a by-pass opening for a by-pass flow between the valve element and the boundary of the orifice when the valve element is in the minimum flow position.

The guide may comprise a peripheral guide wall extending around the orifice. The peripheral guide wall may comprise two or more discrete guide wall elements spaced apart around the orifice to define an opening for the by-pass flow between the valve element and the boundary of the orifice when the valve element is in the minimum flow position.

The gas turbine assembly may include any features of the kit described above with respect to the second aspect of the present disclosure, as installed in the gas turbine assembly.

A gas turbine engine may comprise the gas turbine assembly described herein.

A method of installing a pressure responsive valve may include the valve having an attachment point having a stud for a ball joint, the gas turbine assembly defining a pathway for a cooling flow, the gas turbine including a first component having an orifice for the cooling flow. The method may comprise: installing a mount on a component of the gas turbine assembly, the mount having a socket for receiving the stud of the valve; locating the valve so that the stud is received in the socket; pivoting the valve relative the mount so that the valve in an installation position in which the valve element is registered with a guide provided around the orifice; and clamping the valve in the mount in the installation position.

The guide may have or be used in combination with any of the features of the gas turbine assembly or kit of parts described herein.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### BRIEF DESCRIPTION OF THE DRAWINGS

Embodiments will now be described by way of example only, with reference to the Figures, in which:

FIG. 1 schematically shows an example gas turbine engine;

FIG. 2 schematically shows a portion of a gas turbine assembly depicting a cooling flow pathway;

FIG. 3 schematically shows a passively actuating valve installed in the cooling flow pathway;

FIG. 4 schematically shows a perspective cutaway view of the passively actuating valve within the annulus of the gas turbine assembly.

FIG. 5 schematically shows a cross-sectional view of the valve arrangement of FIG. 3; and

FIG. 6 schematically shows a perspective view of a guide the for the valve arrangement.

### DETAILED DESCRIPTION

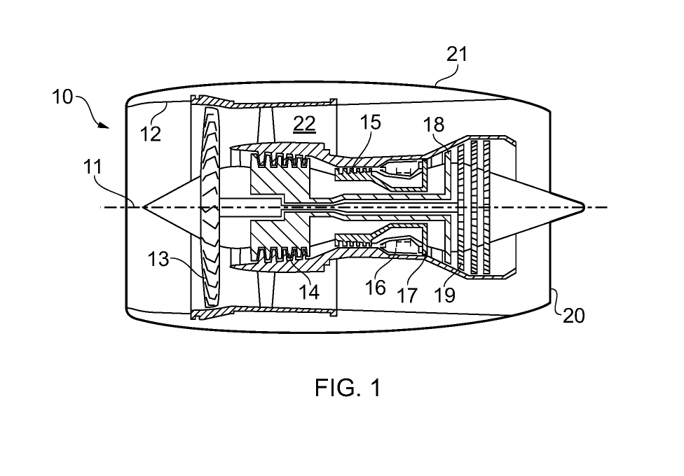

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

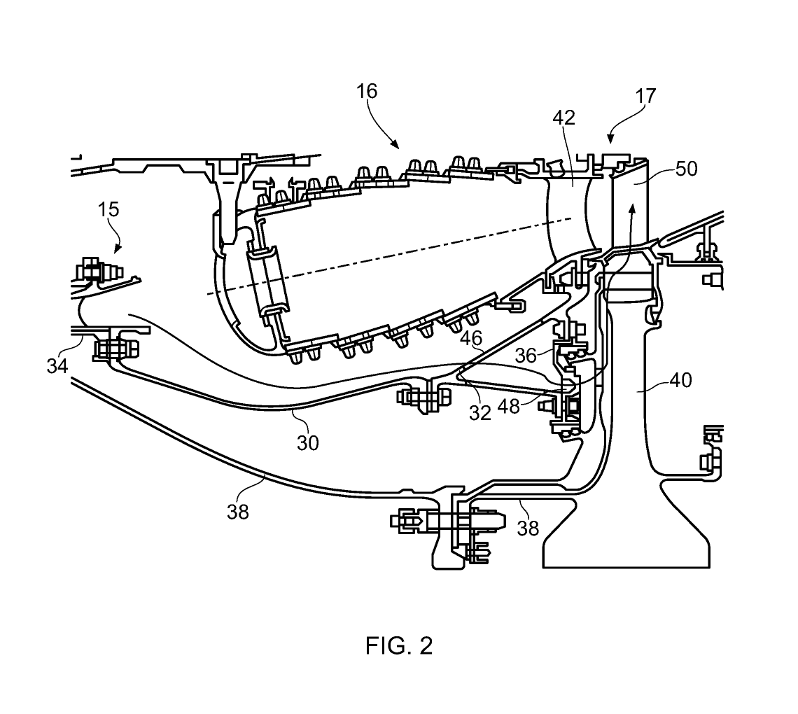

FIG. 2 schematically shows in cross-sectional view a previously considered gas turbine core assembly comprising combustion equipment 16 (i.e. an annular combustion chamber) disposed between the high pressure compressor 15 and the high pressure turbine 17. Radially within the combustion equipment 16 there is an annular combustion forward inner casing (or OGV casing) 30 and a combustion rear inner casing (or CRIC) coupled together at a flange joint and supported between a compressor casing 34 and a pre-swirl nozzle ring 36 which separates the stationary components radially within the combustor from the rotary components associated with the high pressure turbine 17.

The pre-swirl nozzle ring 36 is supported via bearings on a high pressure shaft 38 which extends axially from the high pressure compressor 15 to a rotary turbine disc 40, radially within the OGV casing 30 and CRIC 32.

As shown in FIG. 2, the CRIC 32 extends radially outwardly as it extends axially rearwardly to support and/or seal with the radially inner end of a stator vane ring 42 of the high pressure gas turbine 17. A windage shield 44 extends between the junction between the OGV casing 30 and CRIC 32 and the pre-swirl nozzle ring 36.

As indicated by the arrow 44, a flow of cooling gas from the high pressure compressor 15 by-passes the combustion equipment 16 along a radially inner by-pass pathway between the combustion equipment 16 and the OGV casing 30 and CRIC 32. The flow of cooling gas passes through an orifice 46 in the CRIC 32 and then passes through a pre-swirl nozzle 48 installed in the pre-swirl nozzle ring. The pre-swirly nozzle 48 circumferentially accelerates the flow of cooling gas. The cooling gas then flows radially outwardly along the turbine disc 40 and through an inlet to an internal cooling pathway within a plurality of turbine blades 50 coupled to the disc 40.

In this example, the flow rate of cooling gas along the cooling gas pathway between the compressor 15 and turbine 17 depends on the relative pressure between the respective parts of the system, and the pressure drop through alternative pathways (i.e. through the combustion equipment 16).

Orifices along the cooling gas flow pathway may be sized to allow sufficient flow of cooling gas flow in the most adverse operating condition of the gas turbine engine—i.e. when the pressure distribution within the engine leads to a relatively weak cooling gas flow, but there remains a minimum acceptable flow rate to cool the components of the high pressure turbine 17. At operating conditions other than this most adverse condition, there may be an excess in the cooling gas flow which represents an inefficiency in the gas turbine engine. As is known in the art, any such inefficiency contributes to the weight and specific fuel consumption of the gas turbine engine.

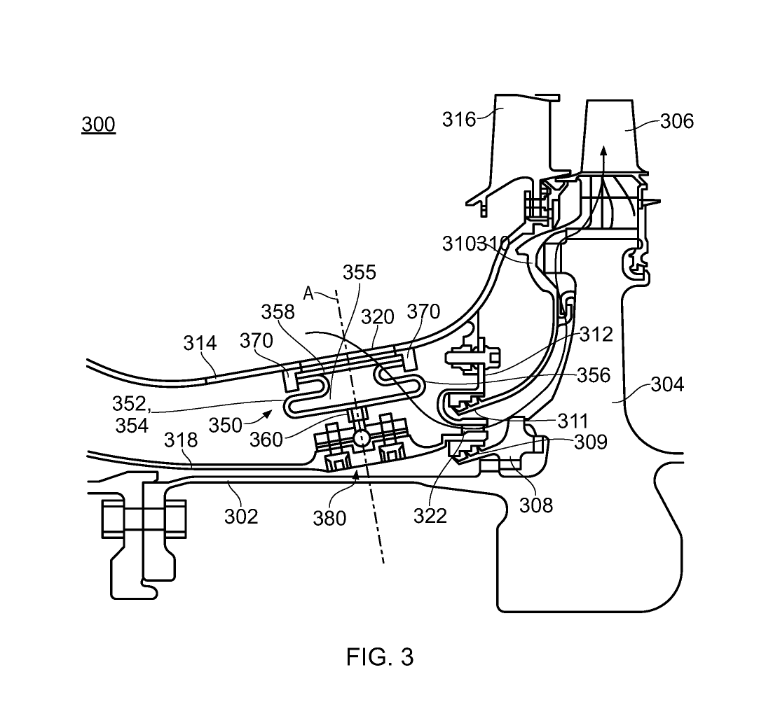

FIG. 3 shows a portion of a further example gas turbine core assembly 300 in cross section, including a high pressure shaft 302 coupled to a turbine disc 304 comprising a plurality of turbine blades 306 (one turbine blade shown). An inner seal carrier 308 is coupled to a forward shoulder of the turbine disc 304 and comprises an inner seal support 309 for supporting stationary (i.e. non-rotating) components of the core assembly 300. A further outer seal carrier 310 is coupled to a radially-outer lug of the turbine disc 304 and extends radially inwardly along an S-shaped curve, terminating at an outer seal support 311 for supporting stationary components of the core assembly 300.

In this example, both the inner and outer seal supports 309, 311 support a pre-swirl nozzle ring 312.

A stationary combustion rear inner casing (CRIC) 314 axially from a forward support (not shown) and is coupled to a radially-outer portion of the pre-swirl nozzle ring 312. The CRIC 314 extends radially outwardly and axially to support and seal with a radially inner end of a stator vane ring 316.

A windage shield 318 extends axially from a forward support (not shown) to couple with a radially-inner portion of the pre-swirl nozzle ring 312. Like the CRIC 314, the windage shield is substantially annular, and is disposed at a radial position between the high pressure shaft 302 and the CRIC 314. The windage shield 318 may be considered a combustor inner casing.

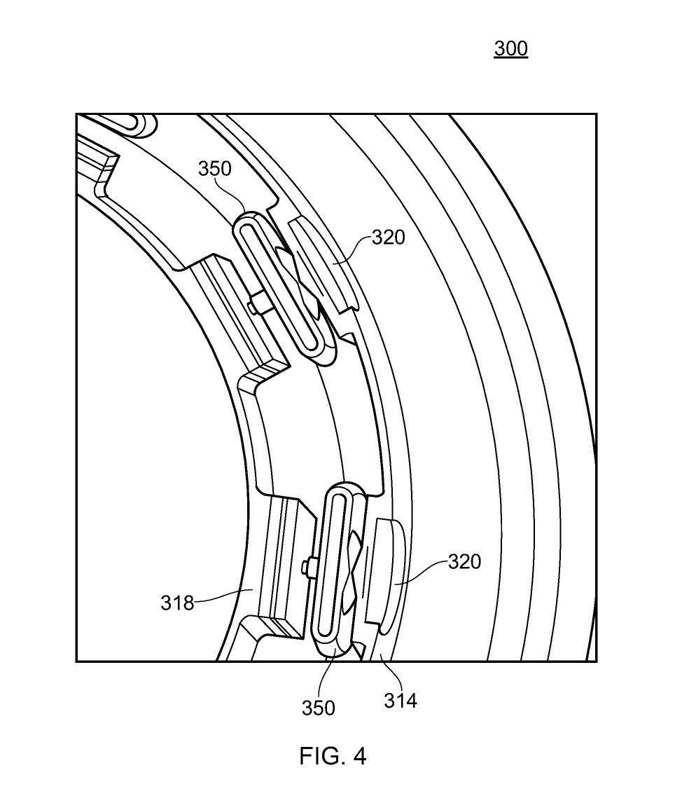

The gas turbine core assembly 300 has a similar pathway for a cooling flow (i.e. cooling gas flow) to that described above with respect to FIG. 2. In particular, as best shown in FIG. 4, which shows a partial segment of the gas turbine assembly 300, the pathway includes flow through a plurality of orifices 320 in the CRIC 314, thereby coupling an upstream portion of the pathway which by-passes combustion equipment (not shown) with a downstream portion of the pathway which extends through pre-swirl nozzles 322 in the pre-swirl nozzle ring 316. The plurality of orifices 320 are circumferentially spaced apart around the CRIC 314 as shown in FIG. 4 (for example, there may be 10 orifices).

In this example, a plurality of passively actuating valves 352 corresponding to the plurality of orifices 320 are provided for controlling the flow rate of a cooling flow through the respective orifices 320 in the CRIC 314.

Referring again to FIG. 3, each passively actuating valve 352 is provided as part of a valve arrangement 350 comprising the valve 352, a guide 370 and a mount 380. The following detailed description of a passively actuating valve arrangement 350 applies equally to all such arrangements provided around the annulus of the gas turbine assembly 300.

As shown in FIG. 3, in this example the passively actuating valve arrangement 350 is installed between the CRIC 314 and the windage shield 318, but it will be appreciated that in other examples such a valve arrangement may be installed in any suitable location to cooperate with a corresponding orifice. Further, the windage shield 318 may be mounted to the CRIC 314, such that when the valve is mounted to the windage shield, it is mounted to the CRIC 314.

Briefly, the mount 380 is fixed to the windage shield 318 opposite the orifice 320 in the CRIC 314 and is configured to secure an attachment point of the valve 352. The valve 352 is linearly extendible and retractable along a valve axis A towards the orifice 320 when secured in the mount 380. When installed, a valve element of the valve 352 is received in the guide 370 which is provided about the orifice 320 to guide linear movements of the guide.

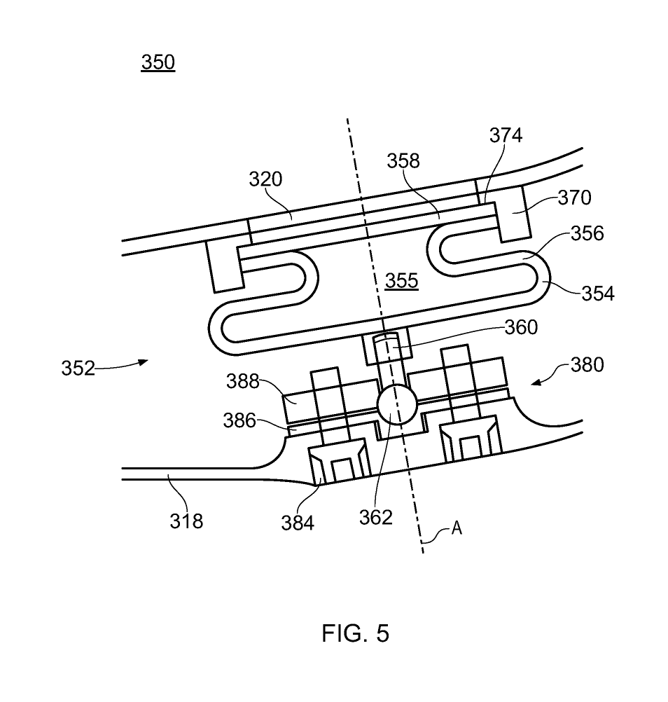

As shown in further detail in FIG. 5, the valve 352 comprises a compressible and expandable valve body 354 defining a sealed chamber 355 therewithin. In this example, the body 354 is axisymmetric (i.e. revolved) about the valve axis A and has an S-shaped wall profile spaced apart from axis such that the body is in the form of a bellows. In this example, the body has a two-part construction including a bellow portion 356 defining a base end, a curved axisymmetric wall (having the S-shaped profile) and an open end opposing the base end; and a valve element 358 fixed to the bellow portion to close the open end. In this particular example, the body 354 comprises a C263 (high temperature Nickel alloy), with the bellow portion 356 being machined by turning and the valve element 358 being a substantially flat plate secured to the bellow portion 356 by welding.

In this example, the walls of the body 354 (i.e. the bellow portion 356 and the valve element 358) are approximately 1.5 mm thick and the diameter of the valve body 354 is approximately 80 mm. In this particular example, the chamber 355 is charged with air at atmospheric pressure, but it will be appreciated that in other examples any suitable at any pressure may be used, or the chamber 355 be empty (i.e. there may be a vacuum).

In this example, the body 354 is configured to displace between 1 mm and 2 mm along the valve axis from idle engine conditions (i.e. at atmospheric pressure and temperature within the gas turbine core assembly) and operational conditions (for example, 40 bar pressure and 650° C.

The valve 352 further comprises an attachment shaft 360 extending from the base end of the bellows 356 and terminating in an attachment stud 362. In this example, both the attachment shaft 360 and the attachment stud 362 of the shaft provide attachment points, since the shaft may be clamped, and the stud may be received in a corresponding recess. In other examples, any suitable attachment point may be used.

In this example, the mount 380 is partially integrally formed with the windage shield 318. In particular, the windage shield 318 includes a profiled portion having four countersunk bolt holes 384 on the radially-inner side. The mount 380 further comprises a separate mounting plate 386 which can be installed over the profile portion of the windage shield 318 and has a complementary profile. The mounting plate 386 includes a hemispherical recess on the opposite side from the windage shield 318 configured to receive the attachment stud 362 of the valve. The mount 380 further comprises two slidable clamp plates 388 configured to be placed over the mounting plate 386 when the attachment stud 362 is received in the recess of the mounting plate 386. The mounting plate 386 has through holes for the bolts and the clamp plates 388 each have a threaded hole, such that the clamp plates can be positioned and the bolts tightened to secure the attachment portion 360 and therefore the valve 352 in place opposite the orifice 320.

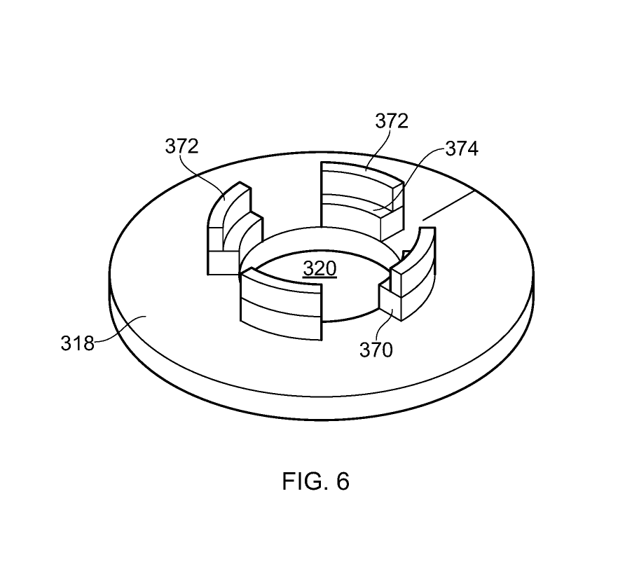

As shown in FIGS. 5 and 6, the guide 370 comprises a peripheral wall extending around the orifice 320 and protruding towards the valve 352 and mount (i.e. towards the windage shield 318).

As best shown in FIG. 6 (in which the wall protrudes upwards), in this example the peripheral wall comprises four discrete semi-annular wall sections 372 circumferentially spaced apart, each wall section having a stop 374 in the form of a shoulder. In this example, the stop 374 is spaced apart from the opening of the orifice 320 along the valve axis such that when the valve element 358 is in an extended position against the stop 374, there is still a minimum flow area defined between the boundary of the orifice 320 and the valve, through the gaps between the wall sections 372.

A method of installing the valve arrangement of FIG. 3 will now be described, by way of example. In use, a kit for installing the valve arrangement 350 is provided, the kit comprising a valve 352 and components of the mount 380 (excluding the integral profiled portion of the windage shield 318). In this example, some parts of the valve arrangement 350 are integral to components of the gas turbine assembly such that they are not provided in the kit, in particular the profiled portion of the windage shield and the guide 370. However, it will be appreciated that in other examples such components may be provided as discrete retro-fittable components.

The mounting plate 386 is installed located over the profiled portion of the windage shield 318 and the attachment stud 362 of the valve 352 is located in the hemispherical recess of the mounting plate 386.

The recess provides for pivoting movement of the valve 352 within the gas turbine assembly, whereas the mounting plate 386 provides for two degrees of translational movement. The valve 352 is manipulated into an installation position in which the valve element 358 opposes the orifice 320 and is substantially coaxial with the peripheral wall of the integral guide 370.

In this example, the valve chamber 355 is pre-charged with nitrogen at atmospheric pressure, and is configured so that the valve element rests against the stoop 374 of the guide at atmospheric pressure and temperature. In other arrangements, the valve body 354 may be provided with a charging port, and the chamber 355 may be filled via the charging port during installation, for example to provide sufficient pressure that the valve element 358 is positioned in an installation configuration relative the orifice 320 and/or guide 370, for example, biased against the stop 374 at a pressure not exceeding a threshold (for example, 10 N/m²).

With the valve 352 in the installation position, the clamping plates 388 are installed over the mounting plate 386 and the attachment stud 362, and the four bolts are installed through the mount 380 and tightened to secure the valve 352 in the installation position.

Assembly of the gas turbine engine is completed and the engine is brought into operation.

During operation pressures and temperatures in the gas turbine core rise such that the body 354 of the valve 352 compresses along the valve axis, thereby increasing a flow gap between the orifice, the valve element 358 and the guide 370. For example, compression along the valve axis of 2 mm may increase the flow area for the cooling flow by approximate 250 mm² per valve arrangement, which would sum to 3000 mm² for a full annulus flow comprising 12 valve arrangements 350 and respective orifices 320.

Accordingly, the passively actuating valve arrangement 350 provides for adjusting the flow area and thereby the flow rate of a cooling flow in a gas turbine. It will be appreciated that the valve arrangement may be configured to conform to a particular displacement or compression profile dependent on pressure.

Whilst a valve arrangement having a valve of a particular shape and configuration has been described, it will be appreciated that the above described valve arrangement is one example. Different shapes and configurations may be considered. For example, the valve body could be substantially square of any suitable shape. The valve element may be separate from the valve body or integral with it. The mount may be of any particular shape, and may be integral with the valve. The valve arrangement may be configured so that an increase in pressure reduces the flow area of the valve arrangement, for example, by fixing the mount to the same component in which the orifice is provide such that the valve element moves away from the orifice. A valve element may be supported by two or more valve bodies coupled to respective mounts, for example the mounts may be provided adjacent an orifice and the valve element may span the orifice supported by the valves on either side.

Although an example of the present disclosure has been described in which the passively-actuating valve is provided to control flow through an orifice in a CRIC (combustion rear inner casing), it will be appreciated that in other examples, the passively actuating valve may be provided to control flow through any other orifice which may define a portion of a pathway for a cooling flow.

Although examples in the present disclosure have been described in which there is a guide for the valve or valve element, it will be appreciated that the guide may be optional the valve may simply oppose an orifice. A kit for installation of the valve arrangement may not include a guide.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A pressure responsive valve for controlling a cooling flow through an orifice in a gas turbine assembly, the valve comprising:
an attachment point;
a valve element; and
a compressible valve body defining a sealed chamber for sealing a volume of compressible gas;
wherein the valve body is configured to act between the attachment point and the valve element so that in use expansion or contraction of the sealed chamber in response to external pressure causes the valve element to move relative the orifice.

2. A pressure responsive valve according to claim 1, wherein the valve element defines a wall of the chamber.

3. A pressure responsive valve according to claim 15, wherein the valve element is a flat plate.

4. A pressure responsive valve according to claim 1, wherein the valve body is in the form of a bellows.

5. A pressure responsive valve according to claim 1, wherein the attachment point comprises a stud for a ball joint.

6. A kit for controlling a cooling flow through an orifice in a gas turbine assembly, the kit comprising:
a pressure responsive valve in accordance with claim 1;
a guide for mounting the pressure responsive valve in fixed relationship with respect to the orifice;
wherein the guide is configured to co-operate with the pressure responsive valve to guide movement of the valve element relative the orifice to meter the cooling flow.

7. A kit according to claim 6, wherein the guide has a stop configured to cooperate with the pressure responsive valve to limit movement of the valve element towards or away from the orifice.

8. A kit according to claim 7, wherein the stop is configured to cooperate with the pressure responsive valve to limit movement of the valve element towards the orifice at a minimum flow position in which the valve element is spaced apart from a boundary of the orifice, and wherein the guide defines an opening for a by-pass flow between the valve element and the boundary of the orifice when the valve element is in the minimum flow position.

9. A kit according to claim 6, wherein the attachment point comprises a stud for a ball joint and the kit further comprises a mount for attaching the attachment point to the gas turbine assembly, the mount comprising a socket configured to cooperate with the stud for pivoting of the pressure responsive valve into an installation position, the mount further comprising a clamp for clamping the valve in the installation position.

10. A gas turbine assembly, comprising:
a fluid pathway for a cooling flow;
a first component having an orifice for the cooling flow;
a pressure responsive valve in accordance with claim 1, wherein the pressure responsive valve is mounted in the assembly so that the pressure responsive valve element opposes the orifice and is moveable relative the orifice in response to pressure variations in the cooling flow so as to vary the fluid pathway.

11. A gas turbine assembly according to claim 10, further comprising a guide mounted to or integrally formed with the first component, wherein the guide is configured to co-operate with the pressure responsive valve to guide movement of the valve element relative the orifice.

12. A gas turbine assembly according to claim 11, wherein the guide has a stop configured to cooperate with the pressure responsive valve to limit movement of the valve element towards the orifice at a minimum flow position in which the valve element is spaced apart from the boundary of the opening.

13. A gas turbine assembly according to claim 12, wherein there is a by-pass opening for a by-pass flow between the valve element and the boundary of the orifice when the valve element is in the minimum flow position.

14. A gas turbine assembly according to claim 10, comprising an annular combustor located around a principal axis of rotation, wherein the pressure responsive valve is located radially inwards of the combustor.

15. A gas turbine assembly according to claim 14, wherein the combustor includes an annular combustion chamber and a radially inner combustor inner casing, wherein the pressure responsive valve is mounted to the combustor inner casing.

16. A gas turbine assembly according to claim 14, further comprising a plurality of pressure responsive valves, wherein the fluid pathway is annular and the pressure responsive valves are circumferentially distributed around the fluid pathway.

17. A gas turbine assembly according to claim 10, comprising a compressor and a turbine, wherein the fluid pathway extends between the compressor and the turbine.

18. A method of installing a pressure responsive valve in a gas turbine assembly defining a pathway for a cooling flow, the gas turbine assembly including a first component having an orifice for the cooling flow, the method comprising:
providing a pressure response valve for controlling a cooling flow through an orifice in a gas turbine assembly, the valve comprising: an attachment point comprising a stud for a ball joint; a valve element; and a compressible valve body defining a sealed chamber for sealing a volume of compressible gas; wherein the valve body is configured to act between the attachment point and the valve element so that in use expansion or contraction of the sealed chamber in response to external pressure causes the valve element to move relative the orifice;
installing a mount on a component of the gas turbine assembly, the mount having a socket for receiving the stud of the valve;
locating the valve so that the stud is received in the socket;
pivoting the valve relative the mount so that the valve is in an installation position in which the valve element is registered with a guide provided around the orifice; and
clamping the valve in the mount in the installation position.
